(19) United States
(12) Patent Application Publication
(10) Pub. No.: US 2009/0106352 A1
(43) Pub. Date: Apr. 23, 2009

(54) Zugidome dating / social interaction system

(76) Inventor: Jonathan Scott Woolfson, Sunny Isles Beach, FL (US)

Correspondence Address: Jonathan Woolfson, 17000 NORTH BAY ROAD # 1608, SUNNY ISLES BEACH, FL, 33160, US

(21) Appl. No.: 11/974,939

(22) Filed: Oct. 17, 2007

(51) Int. Cl. G06F 15/16

(52) U.S. Cl. 709/203

(57) ABSTRACT

A personal interaction and dating system that includes a plurality of individual portable hand-held transmitter and receiver units. The system further includes data storage and transfer mechanisms, personal computer software that is used to filter and prioritize data, and an easily accessible website for further uploading, downloading, and analyzing of acquired data, such that individuals can contact and send personal information to one another in an analytical, nonintrusive, and private method.

### FIELD OF INVENTION

This invention relates to the wireless transmission, storage, and processing of personal information between individuals in an analytical, nonintrusive and private method. More particularly, this invention functions as an aid to individuals who prefer to meet and choose dating partners and/or business entities by analyzing and prioritizing personal data sent to them while carrying hand-held receiving and transmitting units that incorporate data storage and transfer mechanisms.

### BACKGROUND OF THE INVENTION

For as long as there has been introductions and dating between individuals there has been a level of insecurity and fear associated with the initial moments when one individual meets another and has a desire to obtain or share personal information with the other to thereby interact with that other person and possibly begin a relationship. Additionally, in the past it has been difficult, if not impossible, to identify if a particular individual is single and/or interested in dating.

Many times an individual is approached by another individual that is considered undesirable by that individual resulting in a very uncomfortable situation for both individuals.

Therefore, there became an urgent need for a system that can provide a nonintrusive and private way for one individual to show interest in another and thereby send data to that individual for contact and/or dating consideration.

### SUMMARY OF THE INVENTION

The instant invention, also referred to as “Zugidome Social Networking/Dating Devices”, offers the functions discussed above by providing a system that accepts wireless electronic transfers of information between hand-held units via infrared transmissions. The system includes a receiving unit, a transmitting unit, and data storage and transfer mechanisms. The information is then uploaded to a computer that uses software or accesses the “Zugidome” website to aid in the filtering, processing, and prioritizing of that information.

Once an individual has all their received information filtered, processed, and prioritized, the individual can then pick and choose who to contact between the individuals who chose to send their personal information to their hand-held receiver unit. The user who reviews the received profiles can choose to contact or block the user who sent their information to them initially.

Previous dating systems and information transfer devices do not afford this level of data transfer and privacy, and do not offer the ability to see in real time or real life what they are getting, and further, removes the deception that has plagued the internet dating scene.

There are many systems and applications that have been developed for social networking as this is, however, they are brand specific or technology specific, ie. MOTOROLA, T-MOBILE, MATCH.COM, BLUETOOTH, GPS etc., meaning that a cell user of MOTOROLA would not be able to interact with a NOKIA phone, or a BLUETOOTH application could not work with a GPS application for example. The instant invention is designed to work industry wide, and would not experience these downfalls.

The most pertinent patented prior art system that attempts to address the issues of meeting and dating between individuals is as follows:

U.S. Pat. No. 7,249,182 (Heinonen et al)

This system is considered a wireless profile sharing and management system. The main aspect of this system is to process sent information within the device at the time of transfer, then deciding whether to continue to analyze more detailed information based on predetermined criteria. This can result in an immediate blockage of either some or all of the information that an individual might need or actually desire. Further, the type of data that is transferred within this system is limited by the criteria set by the user and/or the software being used, which also limits the ability of the user to gain a clear picture of who they are actually analyzing.

The instant invention allows a more complete transfer of personal information, and taps into the use of a huge internet database that allows the individual to explore and investigate a much larger library of information on any individual that is also part of the system.

Further, the instant invention allows for a greater degree of privacy and anonymity by offering the users a chance to send their initial personal information without immediate filtering, so that the receiving individual can explore all the data of the other at a more convenient time. This also avoids any immediate indications of rejection that may occur with the system of Heinonen et al.

The novel features of the present invention are set forth in the claims herein. The functionality, modes of operation, purposes, and advantages of this invention can be further understood with reference to the following drawings and description of the preferred embodiment.

### BRIEF DESCRIPTION OF THE DRAWINGS

FIG. 1 is a perspective view of a receiver unit

FIG. 2 is a perspective view of a transmitter unit.

FIG. 3 is a view of the circuit board of the infrared (IR) hit recorder/transmitter unit.

FIG. 4 is a view of the circuit board of the infrared (IR) hit recorder/receiver unit.

FIG. 5 are schematic diagrams of members of the infrared (IR) hit recorder/receiver unit.

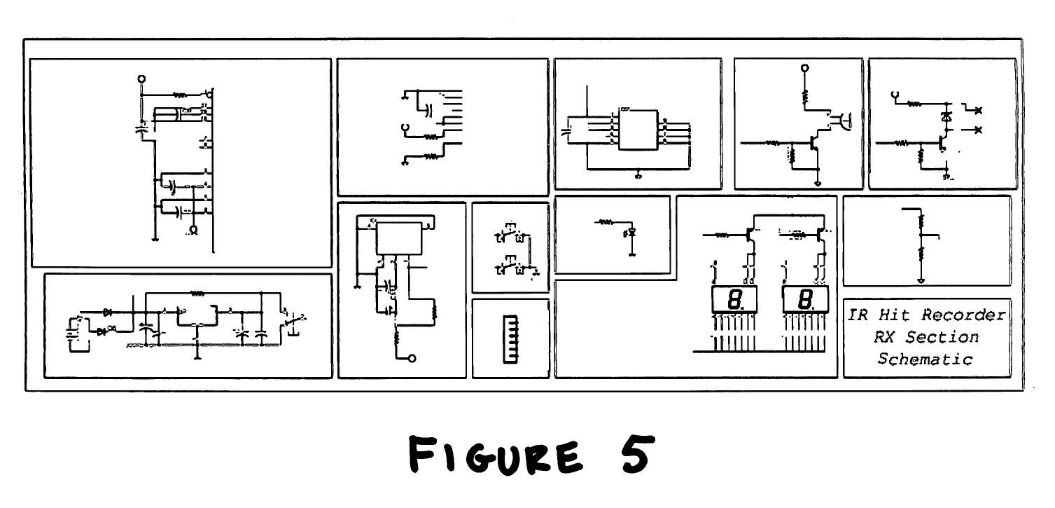

FIG. 6 are schematic diagrams of members of the infrared (IR) hit recorder/transmitter unit.

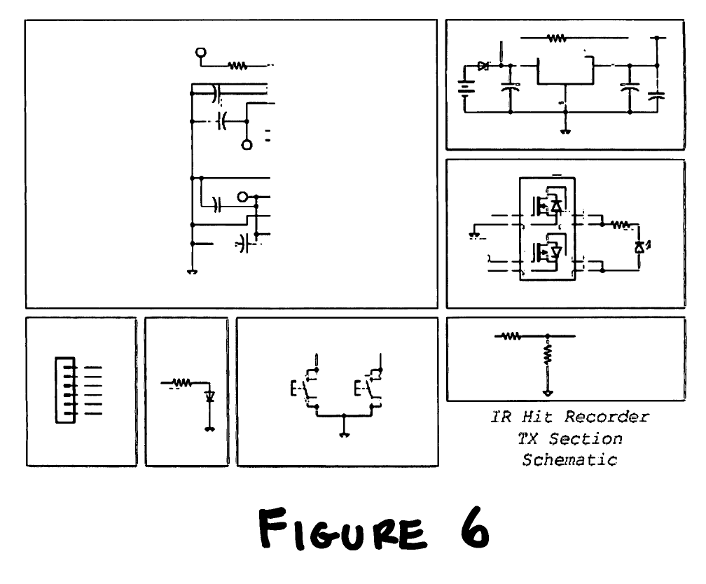

FIG. 7 is a flow chart representing a dating application.

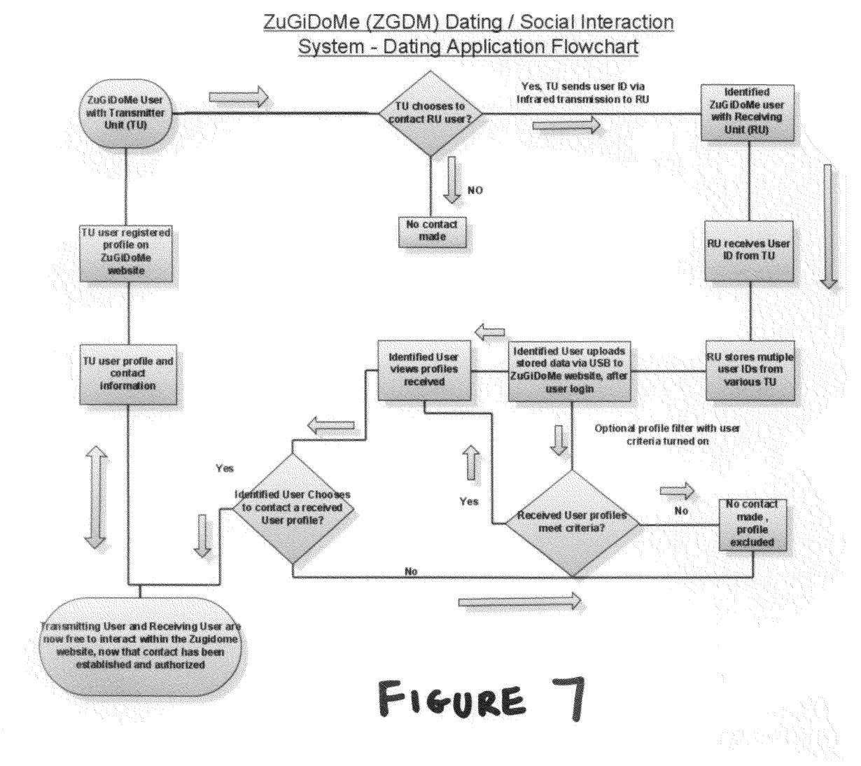

FIG. 8 is a flow chart representing a business application.

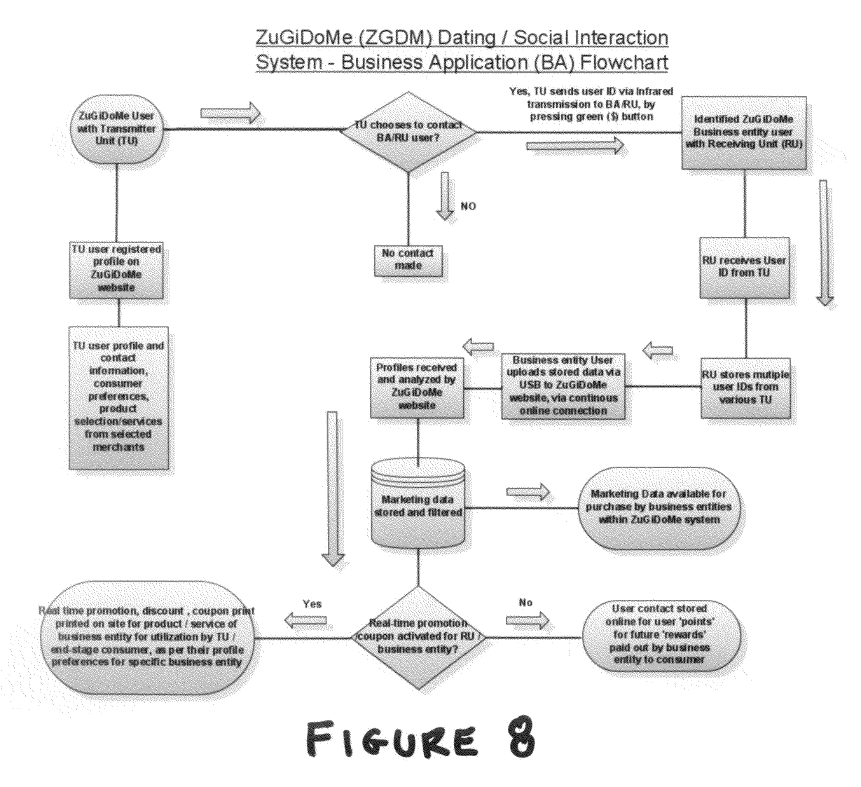

### DESCRIPTION OF THE PREFERRED EMBODIMENT

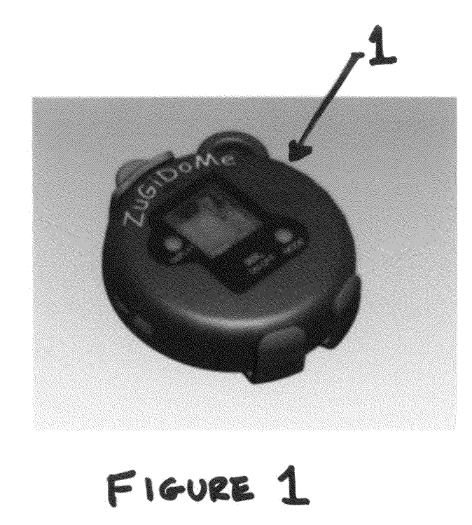

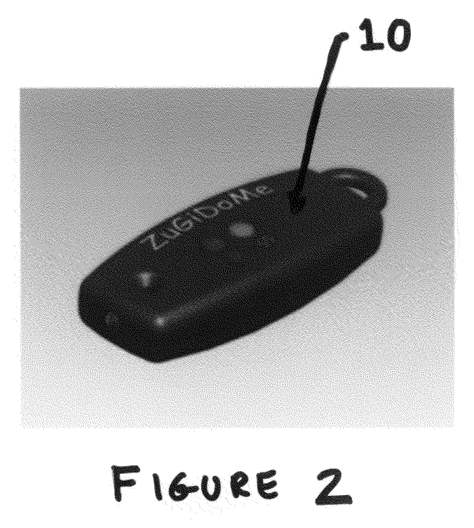

The Personal Interaction and Dating System as set forth herein is generally indicated by reference numerals (1) in FIG. 1 and (10) in FIG. 2.

The preferred embodiment comprises the following:

A Transmitter Unit (TU):

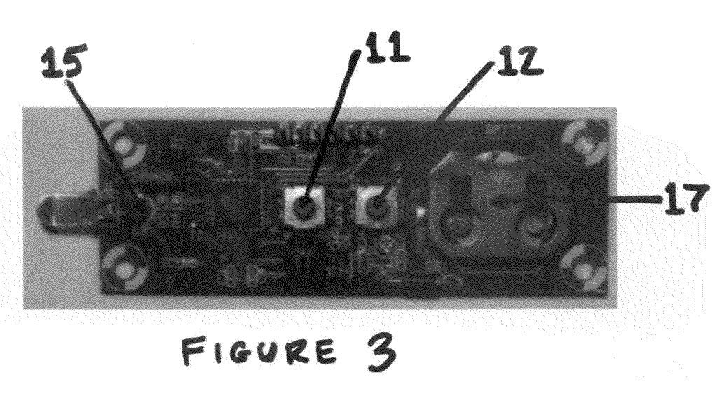

Best shown in FIGS. 2 and 3, which is approximately 1 inch wide×3 inches long and includes a plastic casing for covering the computer board; an infrared transmitter; a red button (11) for “love or dating”, and a green button (12) for “money”, wherein each button transmits a different and unique user ID. Within the transmitter unit there is a LED (15) along with the two switches viz, RED and BLACK. If the RED switch is pressed, the Normal 5 Digit ID [e.g. 0X00 0x30 0x39 i.e 12345] will be transmitted. If the BLACK switch is pressed, the MSB of the 5 Digit ID [e.g. 0XA0 0x30 0x39 ie 12345A] will be altered and transmitted.

Transmission Indications:

Whenever a switch (either RED or BLACK) is pressed, the LED will blink three times and it will go OFF. This is to indicate a successful transmission.

A Receiving Unit (RU):

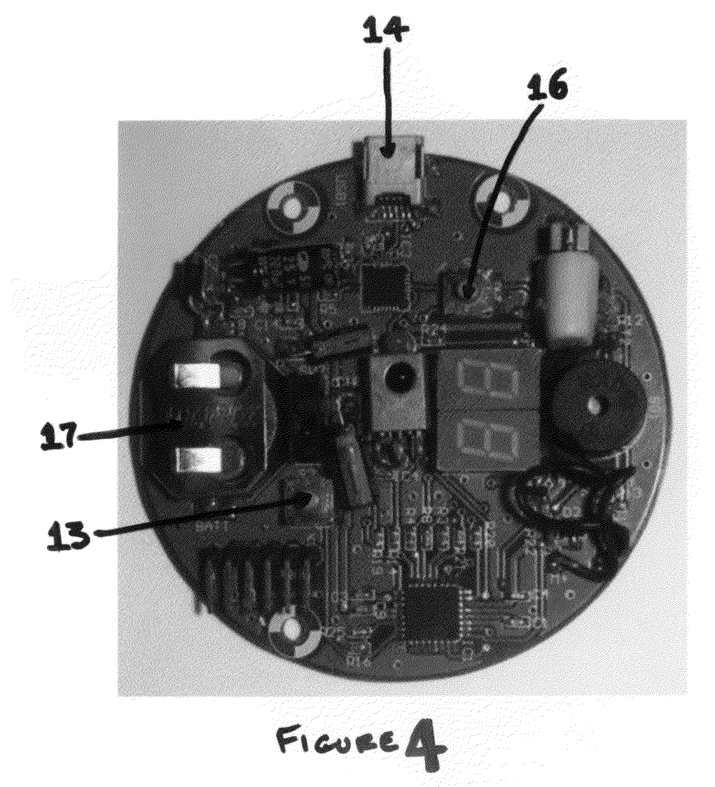

Best shown in FIGS. 1 and 4, which is approximately 3 inches in diameter and includes a clear plastic window to receive infrared data transfer; an on/off switch; a mode switch (13) for choosing between silent, beep, and vibrating modes; a USB port (14) for uploading and downloading of data; a display switch (16), and a data storage device.

Startup Indications:

Once the RU is turned on, the LED will blink for 5 times and will go off. If the battery is low, then while turning ON the RU, the Segment Display will show “Lo” for 3 seconds and then it will automatically go off. When “Lo” message has been displayed, the LED will not blink at the startup. After either of the above, the RU resumes to its normal operation.

Power On Indication:

Once the RU has been turned on, the LED will blink once for every 5 second until the RU is Turned off. This is to indicate to the user that the RU has been turned on.

Reception Indication:

There are 3 modes, in which the RU can alert the user for proper reception of the datum. The modes are SILENT, BEEP, VIBRATE. In the SILENT Mode, the RU will just turn on the LED for 3 seconds in order to alert the user for proper reception of datum. In the BEEP Mode, the RU will turn on the LED for 3 seconds and also will BEEP for 3 seconds in order to alert the user for proper reception of datum. In the VIBRATE Mode, the RU will turn on the LED for 3 seconds and also will VIBRATE for 3 seconds in order to alert the user for proper reception of datum. Once the RU has been turned on, the default Mode will be the SILENT Mode. The Mode can be selected using the MODE switch (13). If the MODE switch is pressed once, the BEEP mode will be selected. The RU will BEEP and the LED will blink for some time as an acknowledgment for the MODE [BEEP] selected. If the MODE switch is pressed again, the VIBRATE mode is selected. The RU will VIBRATE and the LED will blink for some time as an acknowledgment for the MODE [VIBRATE] selected. If the MODE switch is pressed again, the SILENT mode is selected again. The LED will blink for some time as an acknowledgment for the MODE [SILENT] selected. For every press of the MODE switch, a different mode will be selected in the order of SILENT, then BEEP, then VIBRATE. This will be in round-robin fashion. All the received IDs will be stored in a nonvolatile memory. The total number of hits is also stored in a nonvolatile memory. This ensures that even after turning OFF the RU, the datum will not be lost. The number of “HITS” so far recorded can be viewed by pressing the DISPLAY switch. For every ONE press of the DISPLAY switch, the 7-Segment Display will show the number of “Hits” for 3 seconds. Then the 7-Segment Display will automatically turn OFF.

External Communication:

The device has a USB terminal to communicate with a Personal Computer (PC). When connected to the PC one can upload the stored IDs [System IDs of the Transmitters] through the front end software provided.

Erase:

For erasing the stored IDs, both the MODE and DISPLAY switches are to be pressed simultaneously. When both the switches are pressed, the Display will blink “E”,asking for whether to Erase or Not. To cancel the Erase, the DISPLAY switch is to be pressed until the display shows the number of Hits. To Confirm the Erase, the MODE switch is to be pressed until the display shows “0 0”[ZERO].

Power Supply:

Both the Transmitter and Receiver units will be powered up with 3V DC coin cells (17). Whenever the Battery of the TU is LOW, the LED will not blink for every transmission. Instead the LED will stay ON for 3 seconds and then it will go OFF for every transmission.

Software/Website Interaction:

Once the RU is plugged into a USB cable and into a computer that is connected to the internet, the RU will automatically upload received user IDs from the RU to the Zugidome website, once the site opens the user will login, the website will receive the user IDs and then open them for the login user to review and decide what function to do with them at that point (ie, contact, delete, block, etc.)

The preferred embodiment is operational such that individuals can interact with one another in a method herein known as “proximity dating”, which includes being able to find a mate who may cross your path (proximity) in your day to day travels. Then being able to identify an individual who is single, available, and reachable through use of this system and website.

The preferred embodiment further provides users with the ability to see in real time what they are getting and removes deception that has plagued the internet dating scene.

The preferred embodiment further provides users with the ability to remain anonymous while allowing people to express interest and transfer their user ID to your device.

The preferred embodiment further provides users with the ability to view user profiles at a later time and either choose to filter certain parameters or not.

The preferred embodiment further provides users with the ability to view and interact with received user IDs and profiles.

It is important to note that other applications of this system and technology are possible, including a “METHOD OF DOING BUSINESS”. Within the preferred embodiment, this system can also be used upon business premises in order to provide consumers with the ability to receive instant and on-the-spot promotions from various vendors by transmitting their user ID at a given location. An RU at a business site can provide a constant online connection with customers carrying this inventive device which will then generate a coupon, or other rewards based on certain data and/or preferences that the user would have entered on the Zugidome website previously. This has the ability to drive business and customer loyalty.

As a further improvement, the TU & RU can be combined into one unit and the size of the combined TU & RU unit can be made smaller as the technology improves and the components are made smaller. Further, the layout of the electronic components on the computer board can also be rearranged to further reduce the size of the overall unit.

Any and all other obvious modifications to one or more of the parts of this invention are inherently incorporated herein.

What is claimed is:

1. A method of data transfer and analysis comprising the steps of
a. sending data from a transmitter unit to a receiver unit;
b. uploading the data from the receiver unit into a computer;
c. using software to analyze and prioritize the data;
d. basing future decisions on the results.

2. The method of data transfer and analysis as set forth iii claim 1, further including the step of saving the data within the receiver unit before uploading to a computer.

3. The method of data transfer and analysis as set forth in claim 2, further including the step of opening an internet connection to a predetermined website after the information is uploaded from the receiving unit and into a computer.

4. The method of data transfer and analysis as set forth in claim 3, further including the step of retrieving user profiles based on uploaded data after using software to analyze and prioritize the data.

5. The method of data transfer and analysis as set forth in claim 1, wherein the transmitter unit provides each respective individual with two unique user IDs to choose from that contain a different set of information from one another.

6. A method of interaction between individuals and/or business entities comprising the steps of
a. supplying a plurality of individuals with a transmitter unit, and a receiver unit that includes a memory device;
b. each transmitter unit containing profile information on that particular individual;
c. when one individual encounters another individual and determines that they desire the other individual to consider their profile information, sending that data from that individual's transmitter unit, then being received by the other individual's receiver unit, and then being stored within the other individual's receiving unit's memory device;
d. repeating step (c) a plurality of times over a period of time;
e. after said period of time, uploading all the profile information from the memory device into a computer;
e. using software to analyze and prioritize all the profile information;
f. contacting selected individuals based on the results of the software analysis.

7. The method of interacting as set forth in claim 5, wherein each transmitter unit provides the respective individual with two unique user IDs.

8. The method of interacting as set forth in claim 5, further including the step of opening an internet connection to a desired website after the information is uploaded from the memory device into a computer.

9. A system for interaction between individuals comprising
a. at least two portable units, one for each individual, each comprising a transmitter unit for sending personal data; and a receiver unit for receiving personal data;
b. a computer for uploading the information from one of said receiver units and then processing that data;
c. software adapted to analyze and prioritize the data based on personal requirements set by the user in order to aid the user in determining the individuals that they would like to interact with.

10. The system for interacting as set forth in claim 8, wherein each transmitter unit provides the respective individual with two unique user IDs.

11. The system for interacting as set forth in claim 8, wherein when the portable unit is connected to the computer an internet connection is automatically opened to a predetermined website.

12. The system for interacting as set forth in claim 10, wherein the website offers the user the ability to retrieve user profiles based on uploaded data after using software to analyze and prioritize the data.
